(19) United States
(12) Patent Application Publication
(10) Pub. No.: US 2011/0031733 A1
(43) Pub. Date: Feb. 10, 2011

(54) EXPANDABLE FILE FOLDER

(76) Inventor: James C. HUANG, Taichung City (TW)

Correspondence Address: EGBERT LAW OFFICES, 412 MAIN STREET, 7TH FLOOR, HOUSTON, TX, 77002, US

(21) Appl. No.: 12/537,432

(22) Filed: Aug. 7, 2009

(51) Int. Cl. B42F 13/00

(52) U.S. Cl. 281/45

(57) ABSTRACT

The present invention provides an expandable file folder, including a main body, a hanging portion and a locating zipper. The locating zipper includes a first zipper tooth, a second zipper tooth and a zipper head. The first and second zipper teeth are fitted separately with a meshing side on the first and second cover plates of the main body; and the hanging portion is arranged at inner side of the first cover plate for hanging of the file folder. The users can increase the number of file folders depending on the growing quantity of files, and permit the file folders to be used collectively, thus improving its functionality and applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a file folder, and more particularly to an innovative file folder, which can be expanded structurally.

2. Description of Related Art Including Information Disclosed Under 37 CFR 1.97 and 37 CFR 1.98

A file folder is currently a best-selling product that is extensively used for accommodating papers and files. In response to increasing market competition and diversified customer requirements, innovative file folders have to have an improved functional applicability.

The structure of the file folder is considered from different aspects, such as functionality, structural strength, value, user-friendliness, portability and functional classification. In view of the intended functionality, currently available file folders are provided with a partitioned space that can accommodate the files separately for the users. However, with the growing number of files, the users have to prepare several file folders for accommodating these files, leading to possible scattered arrangement of the file folders.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

There is enhanced efficacy of the present invention.

Based on the unique present invention, the expandable file folder is mainly comprised of a main body with the first and second cover plates and also fitted with a locating zipper. The file folders of the present invention can be linked by mating of the locating zippers, and also removed conveniently. With the present invention, the users can increase the number of file folders depending on the growing quantity of files, and the present invention can permit the file folders to be used collectively. With the arrangement of the locating zipper, the first and second cover plates of the single file folder can be covered and retracted, whilst a plurality of file folders can be expanded with improved functionality and applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an external perspective view of a single file folder of the present invention.

FIG. 2 shows a perspective view of the present invention, showing the single file folder being opened.

FIG. 3 shows a perspective view of the actuation of the present invention, showing that two file folders are connected and assembled.

FIG. 4 shows a perspective view of the present invention, after two file folders are connected and assembled.

FIG. 5 shows a sectional view of the hanging portion of the present invention.

### DETAILED DESCRIPTION OF THE INVENTION

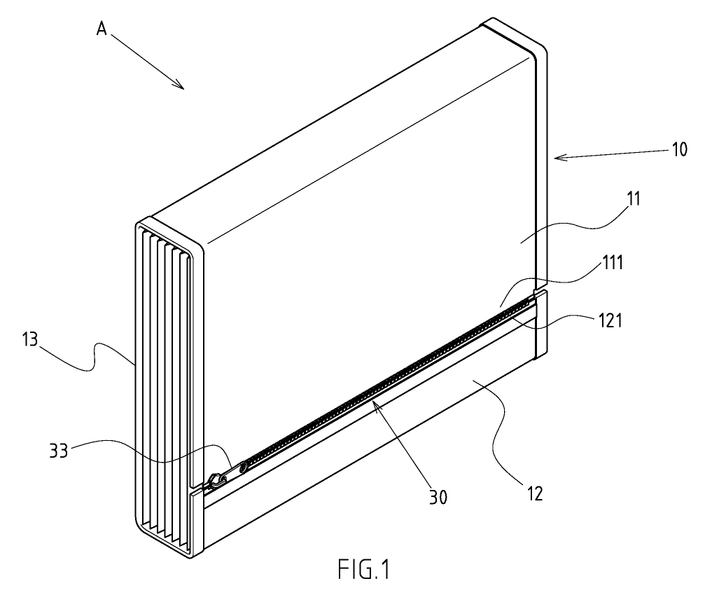

FIGS. 1-3 depict preferred embodiments of an expandable file folder of the present invention. The embodiments are provided for only explanatory purposes with respect to the claims.

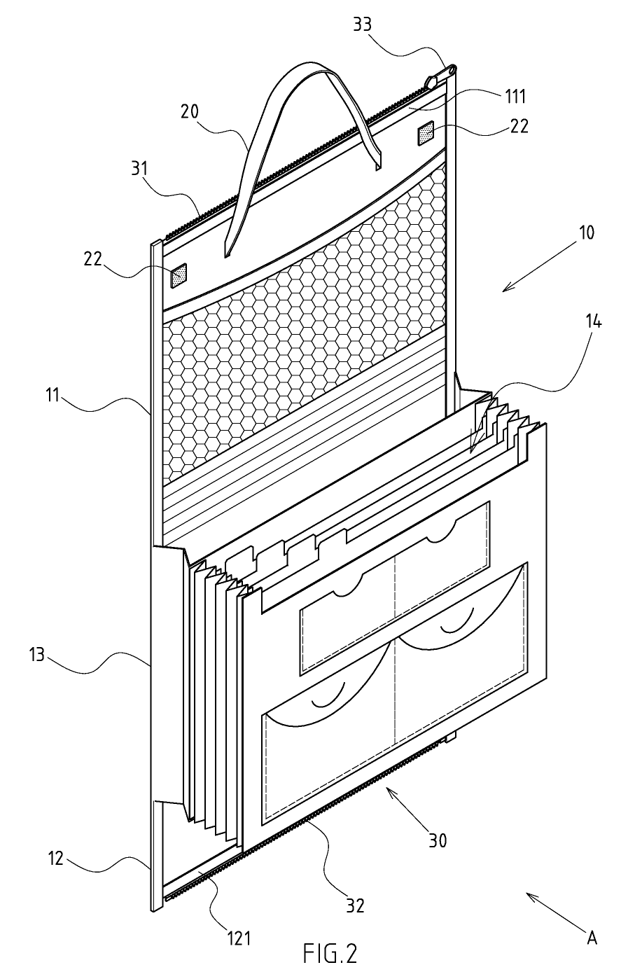

The file folder A comprises a plurality of file folders, or a single one in practice (shown in FIG. 2). The file folder A comprises a main body 10, including at least a first cover plate 11, a second cover plate 12, a rear plate 13 and an accommodation space 14 between the first and second cover plates 11, 12 and the rear plate 13. The first and second cover plates 11, 12 are fitted separately with a meshing side 111, 121. The first and second cover plates 11, 12 can be used for covering the accommodation space 14.

A hanging portion 20 is arranged at an inner side of the first cover plate 11 of the main body 10 for hanging of the file folder A.

A locating zipper 30 includes a first zipper tooth 31, a second zipper tooth 32 and a zipper head 33. The first zipper tooth 31 is mated securely with the meshing side 111 of the first cover plate 11, and the second zipper tooth 32 is mated securely with the meshing side 121 of the second cover plate 12. Moreover, the zipper head 33 is linked to either of the first zipper tooth 31 or the second zipper tooth 32.

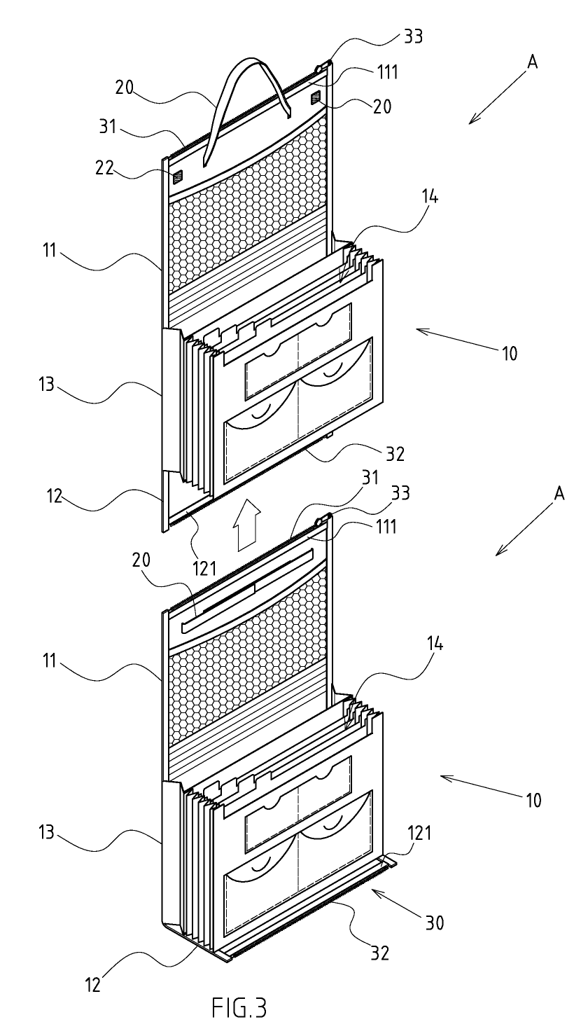

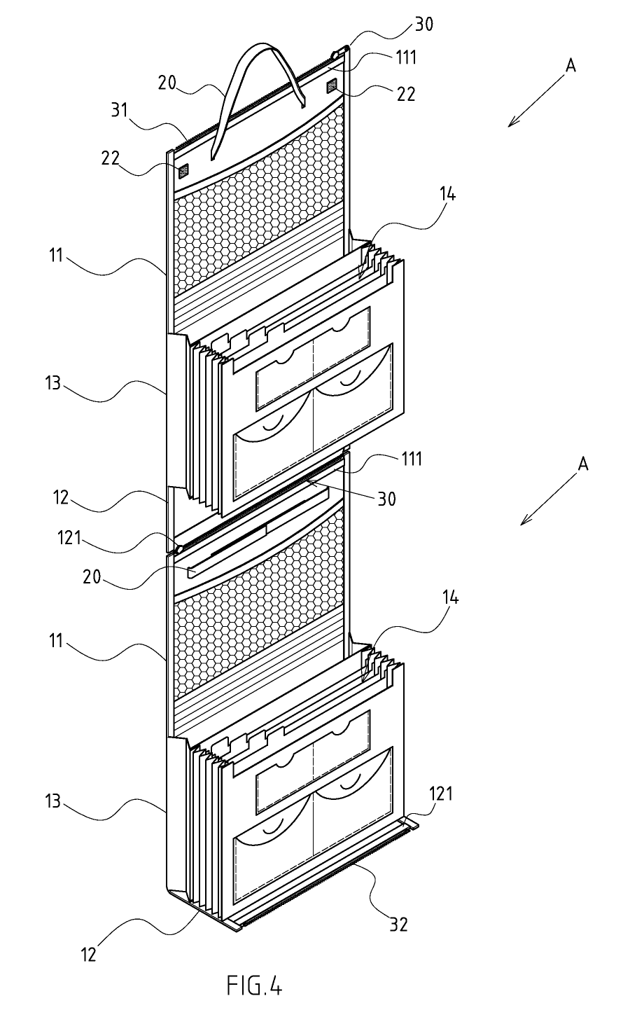

Based on this structural design, the first and second cover plates 11, 12 of the single file folder A can be connected in a covering state (in conjunction with FIG. 1). Referring also to FIGS. 3, and 4, the file folders A can be linked or removed easily and quickly through mating of the locating zippers 30.

Referring also to FIG. 4, a schematic view shows that two file folders A are assembled for easy accommodation by the users, wherein the accommodation space 14 of the assembled file folders A has greatly improved its accommodation capability. Besides, since several file folders A can be used collectively, the users are allowed to operate them more conveniently in an environmental-friendly way.

Referring to FIG. 2, there is an arrangement view of the locating zipper 30 of the present invention, wherein the locating zipper 30 is comprised of a first zipper tooth 31, a second zipper tooth 32 and a zipper head 33 fixed on the meshing side 111, 121 of the first and second cover plates 11, 12. When two file folders A of the same structure are assembled, the positioning effect can be achieved by mating of the first zipper tooth 31 and second zipper tooth 32 in conjunction with the zipper head 33. Furthermore, the locating zippers 30 of the preferred embodiment are arranged in such a way that the file folders are extended or expanded vertically (from top to down), thus realizing simple removal and assembly. Referring to FIG. 1, the first and second zipper teeth 31, 32 of the locating zipper 30 of the single file folder A permit to interlink and cover the first and second cover plates 11, 12, so that the accommodation space 14 of the file folder A can be concealed for the retraction of the main body 10. With the arrangement of the locating zipper 30, the first and second cover plates 11, 12 of the single file folder A can be covered and retracted, and a plurality of file folders A can be expanded.

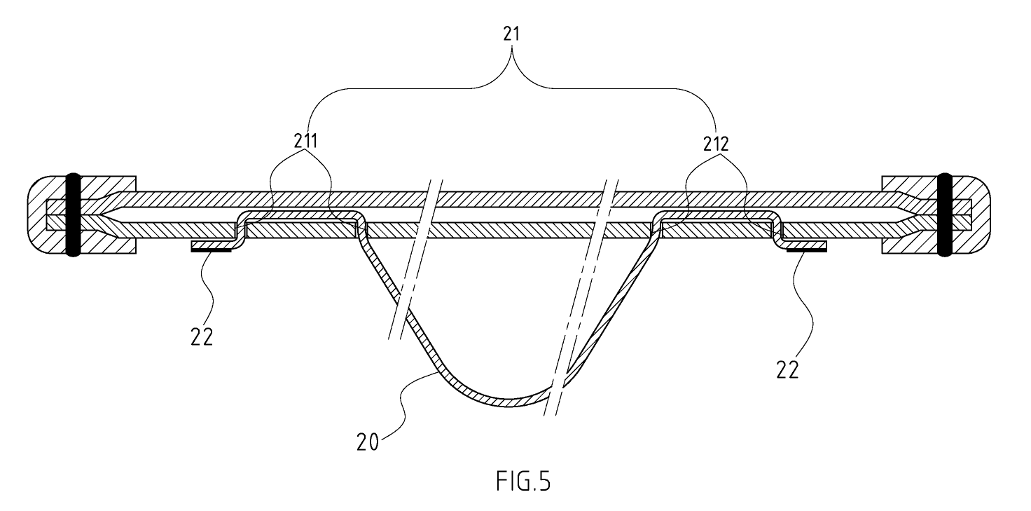

Referring to FIG. 5, the hanging portion 20 is of a banded shape, so it can be threaded onto a limiting portion 21 at inner side of the first cover plate 11. The limiting portion 21 comprises a first group of through-holes 211 and a second group of through-holes 212, which are arranged at intervals to enable the limitation of the banded hanging portion 20 after passing through the first and second group of through-holes 211, 212. Moreover, with the adhesive tape portion 20 set at two opposite ends of the hanging portion 20, the hanging portion 20 can be limited in a hanging state, or the hanging portion 20 can be positioned in a retraction state.

1. An expandable file folder, comprising:
a main body, being comprised of a first cover plate, a second cover plate, a rear plate and an accommodation space between the first and second cover plates and the rear plate, the first and second cover pates being fitted separately with a meshing side;
a hanging portion, arranged at inner side of the first cover plate of the main body; and
a locating zipper, being comprised of a first zipper tooth, a second zipper tooth and a zipper head, said first zipper tooth is mated securely with the meshing side of the first cover plate, said second zipper tooth mated securely with the meshing side of the second cover plate, the zipper head is linked to either of the first zipper tooth or the second zipper tooth, the cover plates being connected in a covering state.

2. The file folder defined in claim 1, wherein the hanging portion is of a banded shape and threaded onto a limiting portion at inner side of the first cover plate, the limiting portion being comprised of a first and a second group of through-holes, arranged at intervals to enable the limitation of the banded hanging portion after passing through the first and second group of through-holes, a adhesive tape portion being set at two opposite ends of the hanging portion, the hanging portion can be limited in a hanging state, or be positioned in a retraction state.
